(19) United States
(12) Patent Application Publication
(10) Pub. No.: US 2015/0260353 A1
(43) Pub. Date: Sep. 17, 2015

(54) LIQUID-FILLED LED BULB HAVING A UNIFORM LIGHT-DISTRIBUTION PROFILE

(71) Applicant: SWITCH BULB COMPANY, INC., San Jose, CA (US)

(72) Inventors: Matrika BHATTARAI, San Jose, CA (US); Kevin CIOCIA, San Francisco, CA (US); Elijah KIM, San Jose, CA (US); Andrew HEISEY, Walnut Creek, CA (US); Myron MORENO, San Jose, CA (US); Ronan LE TOQUIN, Sunnyvale, CA (US); Prahallad IYENGAR, Sunnyvale, CA (US); David HORN, Saratoga, CA (US)

(73) Assignee: SWITCH BULB COMPANY, INC., San Jose, CA (US)

(21) Appl. No.: 14/214,453

(22) Filed: Mar. 14, 2014

(51) Int. Cl. F21K 99/00; F21V 3/04; F21V 29/56

(52) U.S. Cl. CPC F21K 9/1355; F21K 9/50; F21V 29/56; F21V 3/049; F21Y 2101/02

(57) ABSTRACT

An LED bulb includes a base and a shell connected to the base. The shell is filled with a thermally conductive liquid for cooling the bulb. A plurality of LEDs is disposed within the shell. A first set of LEDs of the plurality of LEDs is positioned a first distance with respect to the center of a convex portion of the shell, and at a first angle with respect to a centerline of the LED bulb. A second set of LEDs of the plurality of LEDs is positioned a second distance with respect to the center of the convex portion of the shell, and at a second angle with respect to a centerline of the LED bulb. The first distance, first angle, second distance, and second angle are selected such that the LED bulb has a light-distribution profile that varies less than 20 percent in light intensity over 0 degrees to 135 degrees as measured from an axis from the center of the shell through an apex of the shell.

### BACKGROUND

1. Field

The present disclosure relates generally to liquid-filled light emitting diode (LED) bulbs and, more specifically, to a liquid-filled LED bulb having a uniform light-distribution profile.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in traditional fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb may be multiple orders of magnitude longer than that of an incandescent bulb, for example, 10,000-100,000 hours as opposed to 1,000-2,000 hours.

One challenge to using LEDs, however, is that the light distribution of an LED is not inherently uniform, as stated in relevant portions of the Energy Star specifications. Specifically, a traditional incandescent light bulb produces a light emission using a heated filament, which produces a substantially uniform light intensity over a wide range of emission angles. In contrast, most commercial LEDs function as an area light source and emit light having an intensity that is approximately proportional to the cosine of angle of emission. In an ideal case, the emission profile of an LED may be characterized as a Lambertian emission profile. As a result, the light produced by an LED tends to be most intense in a direction substantially perpendicular to the light-emitting area or face of the LED. Depending, in part, on the relative position of the LEDs in a bulb, the light distribution of an LED bulb may be non-uniform and characterized by brighter and darker regions over a wide range of emission angles.

Accordingly, it is desirable to produce an LED bulb having a uniform light-distribution profile.

### SUMMARY

In one exemplary embodiment, a light-emitting diode (LED) bulb includes a base and a shell connected to the base. The shell is filled with a thermally conductive liquid for cooling the bulb. A plurality of LEDs is disposed within the shell. A first set of LEDs of the plurality of LEDs is positioned a first distance with respect to the center of a convex portion of the shell, and at a first angle with respect to a centerline of the LED bulb. A second set of LEDs of the plurality of LEDs is positioned a second distance with respect to the center of the convex portion of the shell, and at a second angle with respect to a centerline of the LED bulb. The first distance, first angle, second distance, and second angle are selected such that the LED bulb has a light-distribution profile that varies less than 20 percent in light intensity over 0 degrees to 135 degrees as measured from an axis from the center of the shell through an apex of the shell.

### DESCRIPTION OF THE FIGURES

FIGS. 1A-D depict an exemplary liquid-filled LED bulb.

FIGS. 2A-B depict an exemplary support structure for a liquid-filled LED bulb.

FIG. 3 depicts another exemplary support structure for a liquid-filled LED bulb.

FIG. 4 depicts an exemplary chassis for a liquid-filled LED bulb.

FIGS. 5A and 5B depict predicted light distribution uniformity data for a liquid-filled LED bulb.

FIGS. 6A-C depict predicted light distribution uniformity data for a liquid-filled LED bulb.

FIG. 7A depicts a simulated light-distribution profile for a liquid-filled LED bulb.

FIG. 7B depicts a measured light-distribution profiles for a liquid-filled LED bulb.

FIG. 8 depicts the diffusion profile for different shell materials.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb.

As used herein, the term “liquid” refers to a substance capable of flowing. Also, the substance used as the thermally conductive liquid is a liquid or at the liquid state within, at least, the operating ambient temperature range of the bulb. An exemplary temperature range includes temperatures between −40° C. to +40° C. Also, as used herein, “passive convective flow” refers to the circulation of a liquid without the aid of a fan or other mechanical devices driving the flow of the thermally conductive liquid.

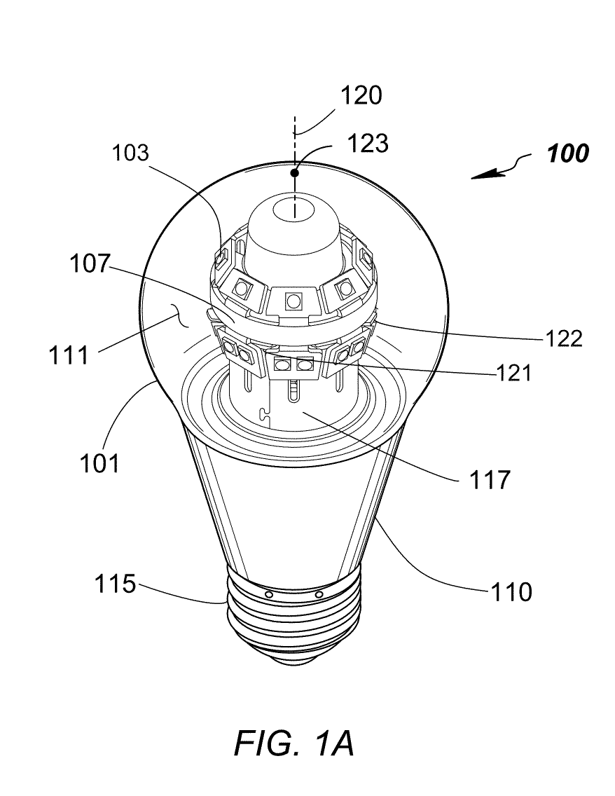

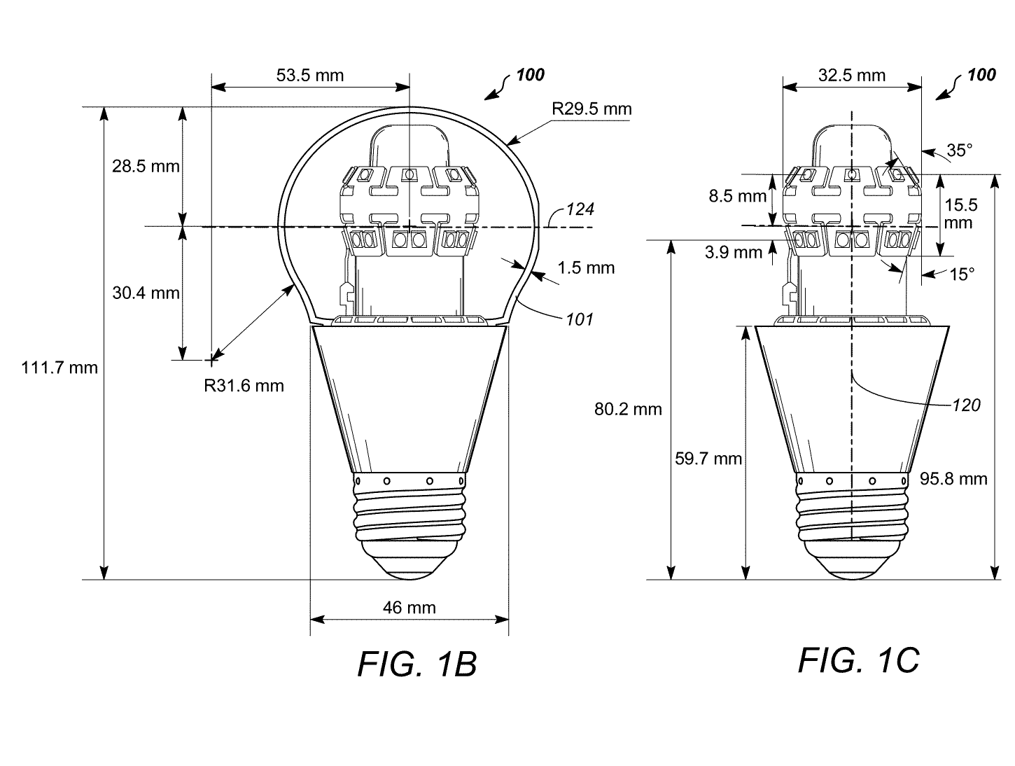

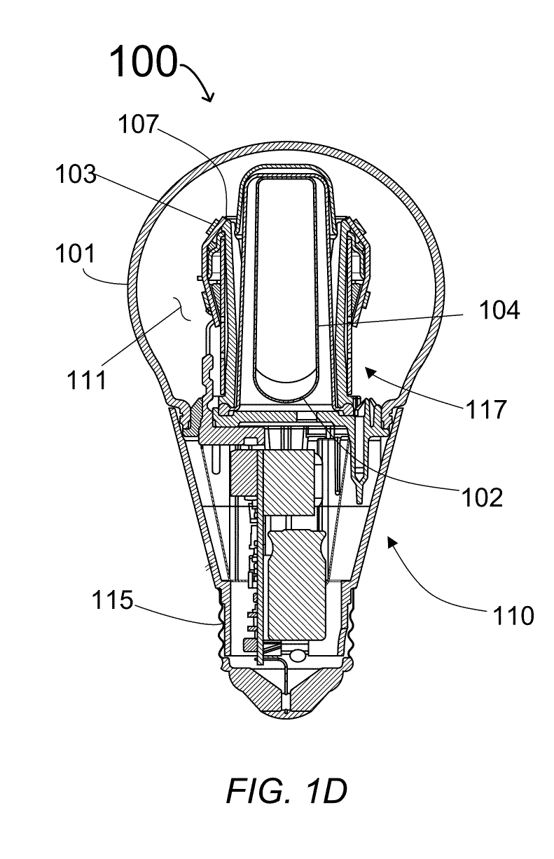

FIGS. 1A-D illustrate an exemplary LED bulb 100. LED bulb 100 includes a shell 101 and a base 110 forming an enclosed volume. For convenience, all examples provided in the present disclosure describe and show LED bulb 100 being a standard A-type form factor bulb. It should be appreciated, however, that the present disclosure may be applied to LED bulbs having any shape, such as a tubular bulb, globe-shaped bulb, or the like.

Shell 101 may be made from any transparent or translucent material such as plastic, glass, polycarbonate, or the like. Shell 101 may include dispersion material spread throughout the shell to disperse light. The dispersion material prevents LED bulb 100 from appearing to have one or more point sources of light.

Base 110 of LED bulb 100 includes a connector base 115 for connecting the bulb to a lighting fixture. In the present embodiment, connector base 115 has threads for insertion into a conventional light socket in the U.S. It should be appreciated, however, that connector base 115 may be any type of connector, such as a screw-in base, a dual-prong connector, a standard two- or three-prong wall outlet plug, bayonet base, Edison Screw base, single pin base, multiple pin base, recessed base, flanged base, grooved base, side base, or the like.

A thermally conductive liquid 111 is disposed within the enclosed volume formed by shell 101 and base 110. Thermally conductive liquid 111 may be any thermally conductive liquid, mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

In the present exemplary embodiment, LED bulb 100 includes a liquid-volume compensation mechanism to facilitate thermal expansion of thermally conductive liquid 111 contained in the LED bulb 100. In the exemplary embodiment depicted in FIG. 1D, the liquid-volume compensation mechanism is a compressible bladder 104, which contains a compressible medium (e.g., a gas, foam, compressible gel, or the like). The liquid-volume compensation mechanism, however, can be a diaphragm, such as a flexible membrane made of an elastomer or synthetic rubber, such as Viton, silicone, fluorosilicone, fluorocarbon, Nitrile rubber, or the like. The liquid-volume compensation mechanism can also be formed from a disk, piston, vane, plunger, slide, closed cell foam, bellow, or the like.

LED bulb 100 includes LEDs 103 disposed within shell 101 and immersed in thermally conductive liquid 111. When LED bulb 100 is operated, light emitted from LEDs 103 passes through thermally conductive liquid 111 and then through shell 101 without passing through an air medium. Thus, thermally conductive liquid 111 and shell 101 together act as a lens for the light produced by LEDs 103. In the present embodiment, the LEDs 103 are made from a gallium nitride (GaN) semiconductor material. It should be recognized, however, that LEDs 103 can be made from various materials.

LED bulb 100 also includes a chassis 117, which is also disposed within shell 101 and immersed in thermally conductive liquid 111. Chassis 117 may be formed from a thermally conductive material, such as aluminum, copper, brass, magnesium, zinc, or the like.

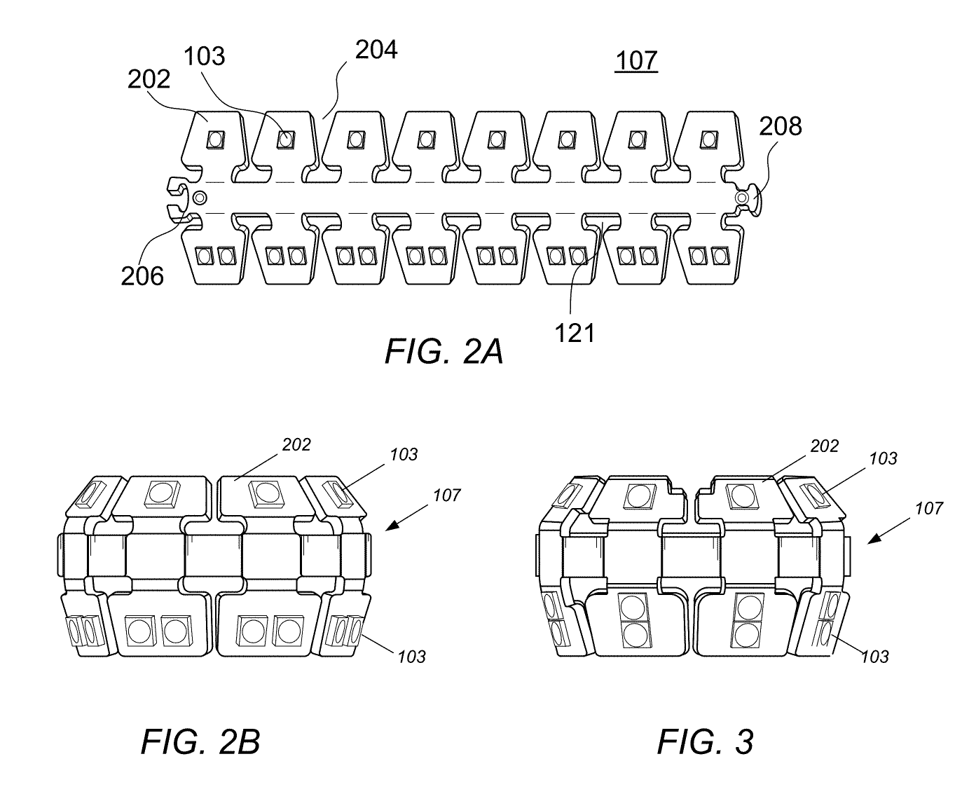

With reference to FIG. 2A, in the present embodiment, LEDs 103 are mounted to support structure 107. In particular, LEDs 103 are mechanically, electrically, and thermally coupled to mounts 202 of support structure 107. Support structure 107 is preferably formed from a composite laminate material. Support structure 107 may comprise a thermally conductive material (e.g., aluminum, copper, brass, magnesium, zinc, or the like) to act as a heat sink and conduct heat energy away from LEDs 103.

As depicted in FIG. 1A, in the present embodiment, support structure 107 is formed in a toroidal configuration around chassis 117. Support structure 107 is secured around chassis 117 by engaging corresponding interlocking members disposed on opposite ends of support structure 107. As shown in FIG. 2A, in the present embodiment, male interlocking member 208 and female interlocking member 206 are disposed on opposite ends of support structure 107. Male interlocking member 208 may be frictionally fitted into female interlocking member 206 to secure support structure 107 around chassis 117 in a toroidal configuration. It should be recognized that interlocking members 206 and 208 shown in FIG. 2A are exemplary and that other configurations may be used to engage together the opposite ends of support structure 107.

With reference to FIG. 1A, in the present embodiment, support structure 107 has openings 121 that engage with corresponding tabs 122 of chassis 117 to secure support structure 107 around chassis 117. Openings 121 of support structure 107 engage tabs 122 of chassis 117 to resist support structure 107 from slipping down or rotating with respect to chassis 117. One advantage of such a configuration is greater ease of assembly and lower production costs where, in the present embodiment, support structure 107 may be secured around chassis 117 without the use of fasteners or adhesives. It should be recognized, however, that instead of support structure 107 having openings that engage with corresponding tabs of chassis 117, support structure 107 may alternatively have tabs that engage with corresponding openings on chassis 117. Additionally, LED bulb 100 may include more than one support structure 107 and the support structures 107 may be attached in various configurations around chassis 117.

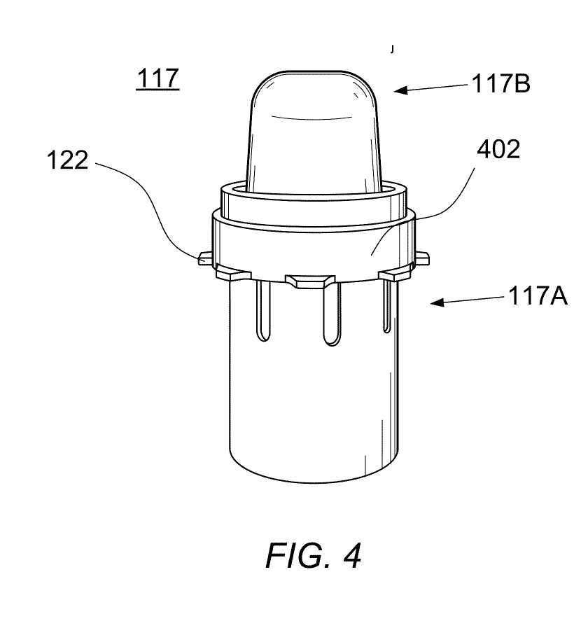

With reference to FIG. 4, in the present embodiment, chassis 117 comprises a body portion 117A and a cap portion 117B. In particular, body portion 117A interlocks with cap portion 117B. In the present embodiment, body portion 117A is tubular shaped, and cap portion 117B is dome shaped. Chassis 117 includes a center ridge portion 402. Center ridge portion 402 extends out from the outer surface of chassis 117. Tabs 122 are disposed on center ridge portion 402. As described above, referring back to FIG. 1A, support structure 107 is attached to chassis 117 at center ridge portion 402 (FIG. 4). It should be recognized, however, that chassis 117 may have various shapes.

Returning to FIG. 1, the base 110 may include one or more components that provide the structural features for mounting bulb shell 101 and chassis 117. Components of the base 110 may include, for example, sealing gaskets, flanges, rings, adaptors, or the like. The base 110 also typically includes one or more electronic circuits for providing electrical power to LEDs 103. The one or more electrical circuits may be configured to convert AC power provided by a conventional light socket into DC power for driving LEDs 103.

As noted above, the light distribution produced by an LED is not inherently uniform, as stated in relevant portions of the Energy Star specification. However, as described in more detail below, LED bulb 100 can be configured to produce a uniform light distribution. For example, the placement of LEDs 103 within shell 101, the shape of shell 101, and the geometry of the other components in LED bulb 100, alone or in combination, can be selected to produce a light-distribution profile that satisfies the Energy Star specifications.

More specifically, relevant portions of Section 7A of the Energy Star Program state that qualifying LED bulbs shall have an even intensity distribution of luminous intensity (candelas) within the 0° to 135° zone (vertically axially symmetrical). Luminous intensity at any angle within this zone shall not differ from the mean luminous intensity for the entire 0 degrees to 135 degrees zone by more than 20%.

With reference to FIG. 1A, in the present embodiment, the locations of LEDs 103 are selected such that LED bulb 100 has a light-distribution profile that varies less than 20 percent in light intensity over 0 degrees to 135 degrees as measured from a centerline axis 120 from the center of shell 101 through an apex 123 of shell 101. More specifically, two sets of LEDs 103 are placed at an angle within the enclosed volume to direct light toward apex 123 and base 110, respectively, of bulb 100. One set of LEDs 103 is arranged in a radial pattern around the centerline axis 120 and angled toward apex 123 of LED bulb 100. A second set of LEDs 103 is arranged in a radial pattern around the centerline axis 120 and angled toward base 110 of LED bulb 100.

FIGS. 1B and 1C depict the placement of the LEDs 103 with respect to other components of LED bulb 100. FIGS. 1B and 1C also depict the dimensions and relative placement of other components in LED bulb 100 that may or may not affect the uniformity of the light distribution of LED bulb 100. It should be recognized that the dimensions of LED bulb 100 are exemplary in nature and may vary to some degree without significantly changing the uniformity of the light distribution.

As shown in FIGS. 1B and 1C, in the present embodiment, LED bulb 100 includes 24 LEDs 103 arranged in a radial pattern. A first set of eight LEDs 103 is attached to an upper portion of support structure 107. In the first set, one LED 103 is mounted to each mount 202. A second set of 16 LEDs 103 is attached to a lower portion of the support structure 107. In the second set, two LEDs 103 are mounted to each mount 202. In the present embodiment, the two LEDs are horizontally aligned. FIG. 3 depicts an alternative embodiment in which the two LEDs are vertically aligned.

In the embodiment depicted in FIGS. 1A-D, the first set of LEDs 103 is positioned at an angle of approximately 35 degrees with respect to centerline axis 120 of LED bulb 100. The first set of LEDs 103 is also positioned approximately 9 mm above center 124 of shell 101. The second set of LEDs 103 is positioned at an angle of approximately −15 degrees with respect to centerline axis 120 of LED bulb 100. The second set of LEDs 103 is also positioned approximately 49 mm below center 124 of shell 101.

As shown in FIG. 1B, in the present embodiment, shell 101 has a constant radius of approximately 29.5 mm for a convex portion of shell 101. Shell 101 also has a concave radius of approximately 32 mm for the concave portion of shell 101 (near the stem body of LED bulb 100). As shown in FIG. 1B, the center of the concave radius is approximately 30 mm below center 124 and approximately 54 mm from centerline axis 120 (FIG. 1C).

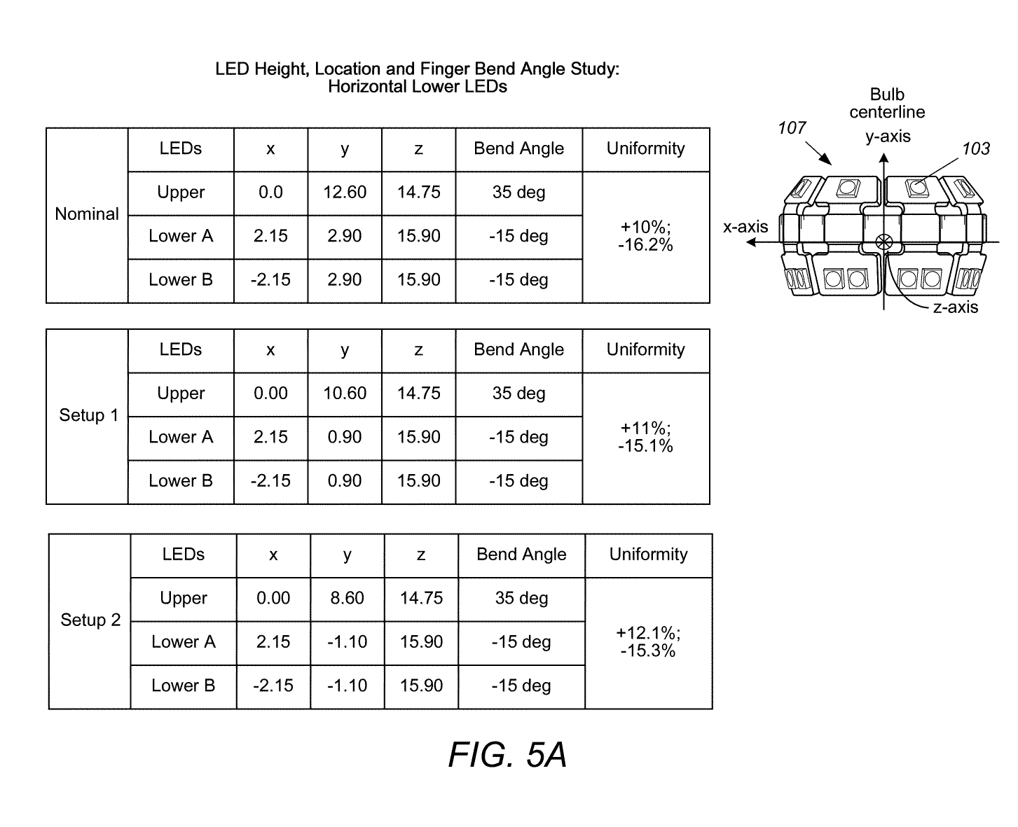

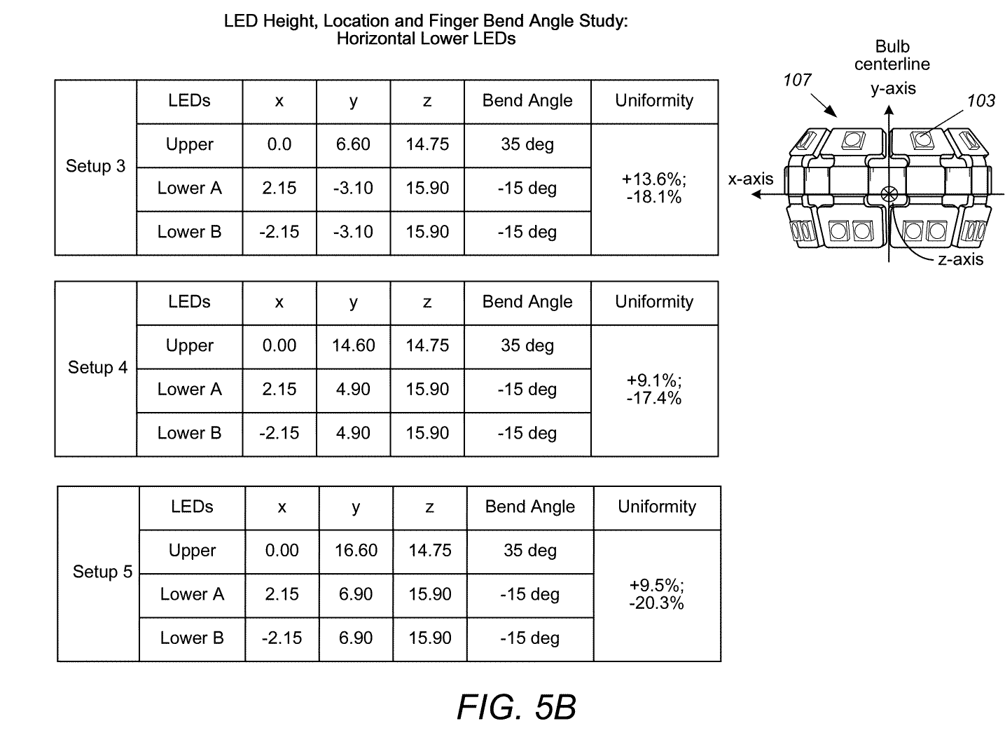

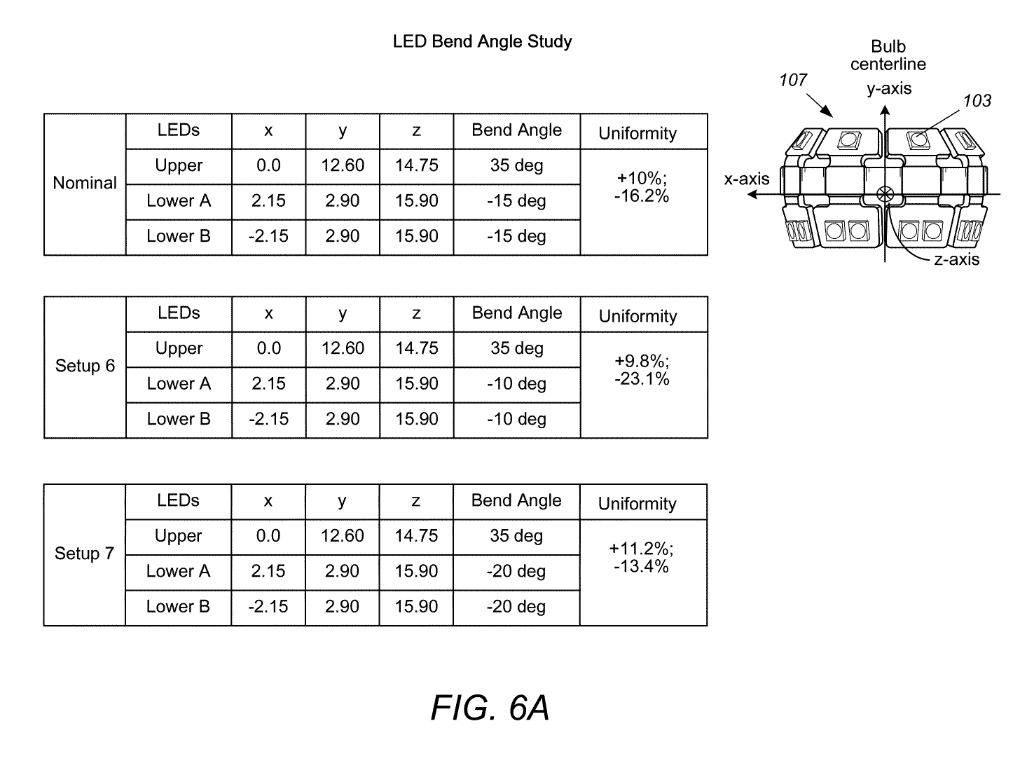

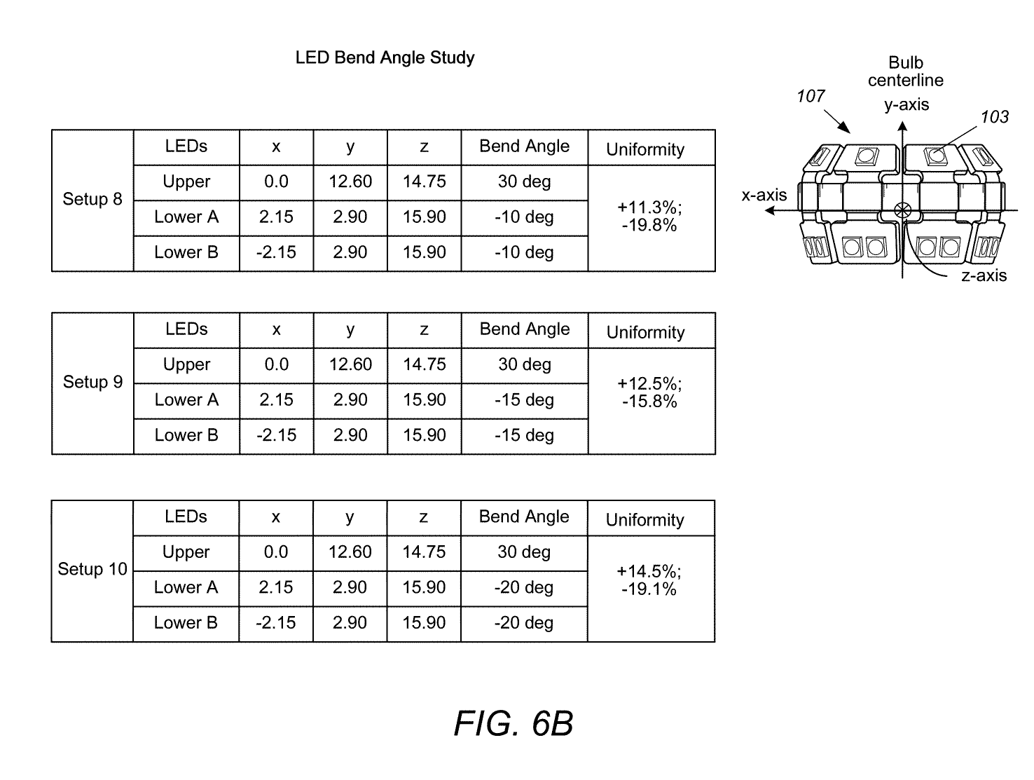

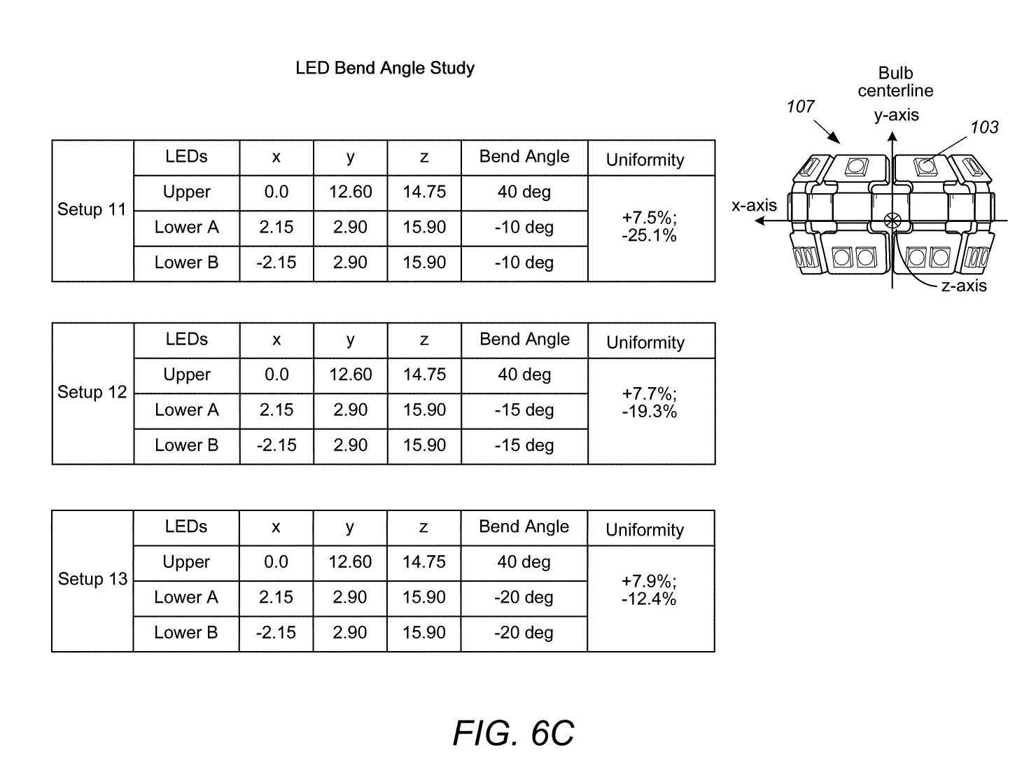

FIGS. 5A, 5B and 6A-C depict optical simulation results for various setups of LED bulb 100 (FIG. 1A) generated using a computer model. The simulations are based on LED bulb 100 (FIG. 1A) having silicone oil as the thermally conductive liquid. In each of the setups, LEDs 103 are arranged into two sets: an upper set of LEDs positioned at an angle toward apex 123 of LED bulb 100 (FIG. 1A) and a lower set of LEDs positioned at an angle toward base 110 of LED bulb 100 (FIG. 1A).

For purposes of the simulations discussed below with respect to 5A, 5B and 6A-C, LEDs 103 are assumed to have a Lambertian emission profile with a peak light intensity at an angle approximately perpendicular to the face of the LED for the purposes of modeling the distribution of light. In the examples provided below, a plastic shell 101 (FIG. 1A) having an index of refraction of approximately 1.58 is filled with thermally conductive liquid 111 (FIG. 1A) having an index of refraction of approximately 1.52.

FIGS. 5A and 5B depict the results of multiple simulations that demonstrate the effect of vertical placement of LEDs 103 on the uniformity of the light distribution. The x, y, and z LED locations shown in the table are in millimeters with respect to the center of the convex portion of shell 101 (FIG. 1A), as indicated by the axes in the diagram to the right of the tables in FIGS. 5A, 5B and 6A-C. Specifically, the y-axis is aligned with centerline axis 120 (FIG. 1A) and the x- and z-axes pass through center 124 of shell 101 (FIG. 1B).

As shown in FIGS. 5A and 5B, for each of the simulations, the angle of the upper set of LEDs 103 is fixed at 35 degrees and the angle of the lower set of LEDs 103 is fixed at −15 degrees. The vertical position of LEDs 103 is changed for each simulation setup, resulting in a different light distribution uniformity for each setup. As shown in FIGS. 5A and 5B, the Nominal Setup and Setups 1-4 result in a light distribution profile that satisfies Energy Star uniformity criteria. Setup 5, which represents the highest vertical LED placement, does not result in a light distribution that satisfies Energy Star uniformity criteria. Based on the simulation results depicted in FIGS. 5A and 5B, a vertical placement for an upper set of LEDs 103 may vary between approximately 15 mm and 6 mm above center 124 of shell 101 (FIG. 1B). The placement for a lower set of LEDs 103 may vary between approximately 5 mm above center 124 of shell 101 (FIG. 1B) and 3 mm below center 124 of shell 101 (FIG. 1B). It should be recognized that different LED angles and/or shell geometry may yield different results. Also, not all combinations of LED placements within these ranges may yield a light distribution that satisfies Energy Star uniformity criteria.

FIGS. 6A-C depict the results of multiple simulations that demonstrate the effect of angle placement of LEDs 103 on the uniformity of the light distribution. As shown in FIGS. 6A-C, for each of the simulations, the vertical placement of the upper set of LEDs 103 is fixed at 12.6 mm and the vertical placement of the lower set of LEDs 103 is fixed at 2.9 mm. The angle of LEDs 103 with respect to centerline axis 120 (FIG. 1A) is changed for each simulation setup, resulting in a different predicted light distribution uniformity for each setup. As shown in FIGS. 6A-C, the Nominal Setup, Setups 7-10, Setup 12, and Setup 13 result in a predicted light distribution profile that satisfies Energy Star uniformity criteria. Setup 6 and Setup 11 do not result in a light distribution that satisfies Energy Star uniformity criteria. Based on the simulation results depicted in FIGS. 6A-C, the angle of an upper set of LEDs 103 may vary between approximately 40 and 30 degrees with respect to centerline axis 120 (FIG. 1A). The angle of a lower set of LEDs 103 may vary between approximately −10 and −20 degrees with respect to centerline axis 120 (FIG. 1A). It should be recognized that different vertical placement of LEDs 103 and/or shell geometry may yield different results. Also, not all combinations of bend angles within these ranges may yield a light distribution that satisfies Energy Star uniformity criteria.

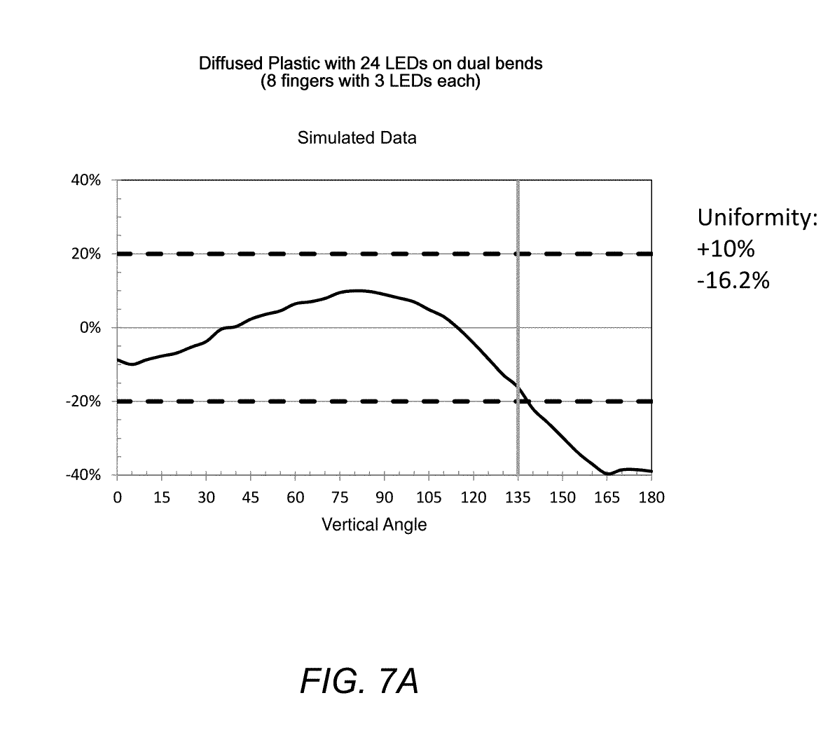

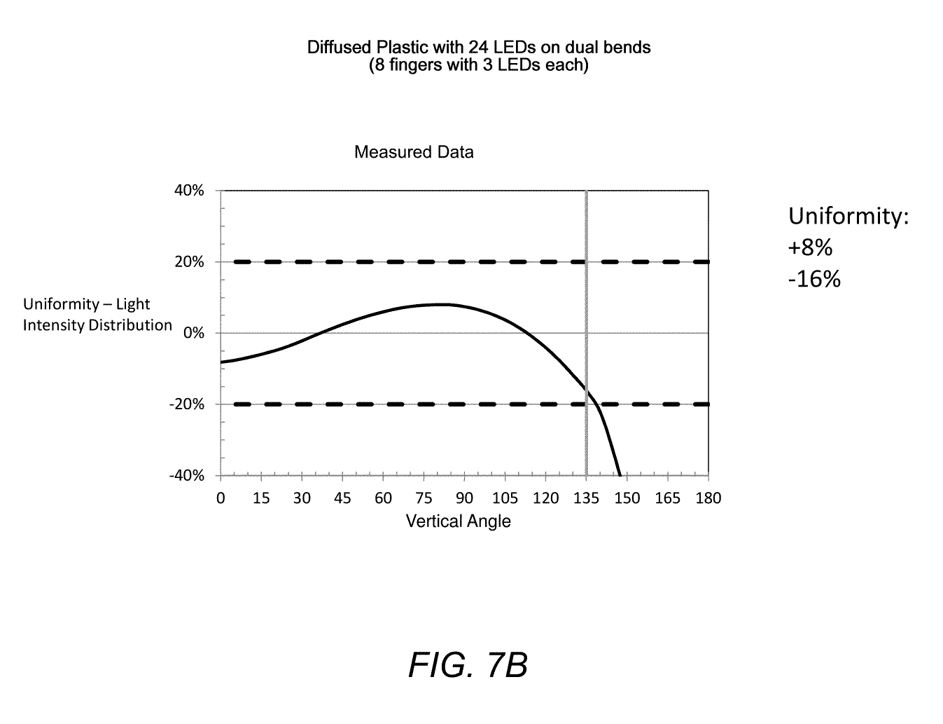

FIG. 7A depicts the predicted light-distribution profile for LED bulb 100 (FIGS. 1A-D) generated using a computer model. The computer model assumed a Lambertian emission profile with a peak light intensity at an angle approximately perpendicular to the face of an LED for the purposes of modeling the distribution of light. Typically, less light is emitted from an LED as the emission angle from the face of the LED is increased.

As shown in FIG. 7A, the predicted light-distribution profile has a uniformity within +10% and −16.2% of the average intensity between 0 degrees and 135 degrees, as measured from an axis through center 124 of shell 101 (FIG. 1B) through apex 123 of LED bulb 100 (FIG. 1A). Thus, LED bulb 100 shown in FIGS. 1A-D produces a light-distribution profile that satisfies Energy Star uniformity criteria.

FIG. 7B depicts the measured light-distribution profile of an actual bulb as compared to the light-distribution profile of a simulated LED bulb having the same setup. As shown in FIGS. 7A and 7B, the measured light distribution of the actual LED bulb corresponds to the light distribution predicted by the simulation. The measured data shows a light-distribution uniformity of +8% to −16% (FIG. 7B), which roughly corresponds to the simulated values of +10% to −16.2% (FIG. 7A).

The uniformity of the light distribution may also depend on the optical properties of shell 101. In general, shell 101 may be made from any transparent or translucent material such as plastic, glass, polycarbonate, or the like. In some cases, it may be desirable to have an LED bulb having a diffuse shell for aesthetic reasons. For example, a diffuse shell hides or masks the internal components of the LED bulb and gives the LED bulb a more uniform “frosted” appearance.

In the present embodiment, shell 101 of LED bulb 100 is made from a diffuse plastic material that diffuses or scatters light that passes through shell 101. In alternative embodiments, the shell may be made from a clear material having a diffuse coating applied to a surface of the shell.

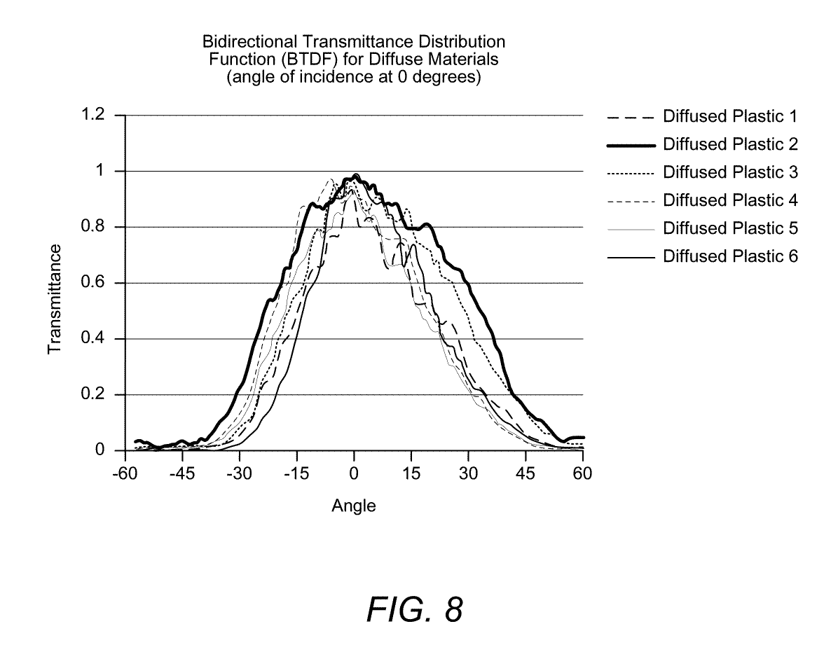

The amount of diffusion for a shell can be quantified with respect to a light-diffusion profile. FIG. 8 depicts the light-diffusion profile of different types of diffusing plastics that can be used for the shell. The bi-directional transmittance distribution function (BTDF) represents the amount of light that is transmitted through the plastic as a function of the angle of transmittance (i.e., the angle at which the transmitted light intensity is measured). For the example depicted in FIG. 8, the source light (a laser) has an angle of incidence of 0 degrees, and the resulting light intensity is measured on the other side of the plastic between 0 degrees and 60 degrees to either side (+/−60 degrees). Typically, the light transmittance is highest at an angle of transmittance of roughly 0 degrees (near the angle of incidence) and drops as the angle is swept through +/−60 degrees. Generally, a more diffuse material will scatter more light further from 0 degrees than a less diffuse material. In the examples provided herein, a diffuse shell includes materials having a BTDF that produces more than half of the maximum light intensity at angles greater than 15 degrees from 0 degrees (angle of incidence) and less than 60 degrees from 0 degrees. This is exemplary in nature and, in other configurations, a material may be considered diffuse using different criterion.

Although a feature may appear to be described in connection with a particular embodiment, one skilled in the art would recognize that various features of the described embodiments may be combined. Moreover, aspects described in connection with an embodiment may stand alone.

We claim:

1. A liquid-filled light-emitting diode (LED) bulb comprising:
a base;
a shell connected to the base;
a plurality of LEDs disposed within the shell; and
a thermally conductive liquid held within the shell and disposed between the plurality of LEDs and the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first distance, second distance, first angle, and second angle are selected such that the LED bulb has a light-distribution profile that varies less than 20 percent in light intensity over 0 degrees to 135 degrees as measured from an axis from the center of the shell through an apex of the shell.

2. The liquid-filled LED bulb of claim 1, wherein when the LED bulb is operated, light emitted from the plurality of LEDs passes through the thermally conductive liquid and through the shell.

3. The liquid-filled LED bulb of claim 1, wherein the first distance ranges from 6 mm to 15 mm above the center of the convex portion of the shell and the second distance ranges from 3 mm below to 5 mm above the center of the convex portion of the shell.

4. The liquid-filled LED bulb of claim 1, wherein the first angle ranges from 30 degrees to 40 degrees with respect to the centerline of the LED bulb and the second angle ranges from −10 degrees to −20 degrees with respect to the centerline of the LED bulb.

5. The liquid-filled LED bulb of claim 1, wherein the plurality of LEDs are positioned in a radial array around the axis from the center of the shell through an apex of the shell, the radial array having a diameter of approximately 32 mm.

6. The liquid-filled LED bulb of claim 1, wherein the shell is made from a clear material that does not scatter light emitted by the plurality of LEDs.

7. The liquid-filled LED bulb of claim 1, wherein the shell is made from a diffuse material that is configured to scatter light emitted by the plurality of LEDs.

8. The liquid-filled LED bulb of claim 1, wherein the shell includes a diffuse coating that is configured to scatter light emitted by the plurality of LEDs.

9. The liquid-filled LED bulb of claim 1, wherein the diffuse material has a bidirectional transmittance distribution function (BTDF) that, for light that is perpendicularly incident to the surface, results in more than half of the maximum light intensity at angles greater than 15 degrees from the angle of incidence and less than 60 degrees from the angle of incidence.

10. The liquid-filled LED bulb of claim 1, wherein the second set of LEDs of the plurality of LEDs includes multiple pairs of LEDs that are horizontally aligned.

11. The liquid-filled LED bulb of claim 1, wherein the second set of LEDs of the plurality of LEDs includes multiple pairs of LEDs that are vertically aligned.

12. The liquid-filled LED bulb of claim 1, further comprising:
a support structure disposed within the shell, the support structure having a first set of upper mounts and a second set of lower mounts, wherein the first set of LEDs are attached to the first set of upper mounts and the second set of LEDs are attached to the second set of lower mounts.

13. The liquid-filled LED bulb of claim 12, wherein the support structure is made from a sheet of laminate material that is formed into a generally toroidal shape.

14. The liquid-filled LED bulb of claim 12, wherein the support structure is made from a sheet of laminate material, wherein the first set of upper mounts and the second set of lower mounts are bent at an angle and the laminate material is formed into a generally toroidal shape.

15. The liquid-filled LED bulb of claim 12, further comprising;
a chassis disposed within the shell, wherein the chassis is substantially aligned with a centerline of the LED bulb, and the support structure is attached to the chassis.

16. A method of making a liquid-cooled light-emitting diode (LED) bulb, the method comprising:
obtaining a base;
connecting a shell to the base;
placing a plurality of LEDs within the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first distance, second distance, first angle, and second angle are selected such that the LED bulb has a light-distribution profile that varies less than 20 percent in light intensity over 0 degrees to 135 degrees as measured from an axis from the center of the shell through an apex of the shell; and
filling the shell with a thermally conductive liquid.

17. A method of making a liquid-filled light-emitting diode (LED) bulb having a light-distribution profile that satisfies uniformity criteria, the method comprising:
obtaining a base;
obtaining a shell having a first index of refraction;
obtaining a thermally conductive liquid having a second index of refraction;
calculating a first angle and a first distance for a first set of LEDs of a plurality of LEDs based on the first index of refraction and the second index of refraction; and
calculating a second angle and a second distance for a second set of LEDs of the plurality of LEDs based on the first index of refraction and the second index of refraction,
wherein the first angle, the first distance, the second angle, and the second distance result in a light-distribution profile that varies less than 20 percent in light intensity over 0 degrees to 135 degrees as measured from an axis from the center of the shell through an apex of the shell;
positioning the first set of LEDs at the first angle and the first distance within the shell;
positioning the second set of LEDs at the second angle and the second distance within the shell;
attaching the shell to the base; and
filling the shell with the thermally conductive liquid.
